(19) United States
(12) Patent Application Publication
(10) Pub. No.: US 2020/0404610 A1
(43) Pub. Date: Dec. 24, 2020

(54) METHOD AND A SYSTEM FOR LOCATING WIRELESS ELECTRONIC DEVICES

(71) Applicant: Telstra Corporation Limited, Melboume, Victoria (AU)

(72) Inventors: Alan CROUCH, South Yarra, Victoria (AU); Jan Gerhardus LOOTS, Mosman, New South Wales (AU); Jason BIRD, Robina, Queensland (AU); Ed BOBEFF, Hawthorn East, Victoria (AU)

(21) Appl. No.: 16/651,828

(22) PCT Filed: Sep. 26, 2018
(86) PCT No.: PCT/AU2018/051052

§ 371 Date: Mar. 27, 2020

(30) Foreign Application Priority Data
Sep. 28, 2017 (AU) 2017903947
Aug. 23, 2018 (AU) 2018903106

(51) Int. Cl. H04W 64/00

(52) U.S. Cl. CPC H04W 64/00

(57) ABSTRACT

A wireless electronic device (110) that executes the steps of: (a) receiving, from a plurality of electronic devices, a unique identifier associated with each electronic device; (b) identifying, from the plurality of electronic devices, at least one listening agent device (120); and (c) sending scan data to the listening agent device (120). The scan data includes the unique identifiers received from one or more of the plurality of electronic devices other than the listening agent device (120), and a unique tracking identifier associated with the wireless electronic device (110). The steps (a) to (c) are performed using a wireless communications protocol, such as Wi-Fi or Bluetooth. For Wi-Fi, the unique identifier is received in a first 802.11 management frame of a probe response; and the scan data is sent in a vendor-specific information element (VSIE) of a second 802.11 management frame of a probe request.

### FIELD

The present invention generally relates to a method and system for locating wireless electronic devices.

### BACKGROUND

Locating or tracking systems have been used to assist individuals or entities in locating and finding their lost belongings or assets, e.g., vehicles, personal computers, or mobile phones. Tracking devices such as wearable and attached electronic devices have been developed for tracking individuals and possessions, e.g. pets, vehicles, bikes, bags, tools.

The existing asset tracking systems usually focus on small scale solutions, shorter-range personal network approaches such as Bluetooth, or outdoor longer-range network technologies such as GPS and cellular networks. However, these systems do not deliver both short and long-range network coverage at significant scale while utilising existing network infrastructures, with high coverage density, and reduced cost in form that is suitable for mass market consumers, small business, and enterprise nationwide services.

For example, some “noncooperative” or “passive” tracking systems have been proposed for tracking mobile devices or monitoring crowds. In such a system, one or a number of monitoring stations are used for tracking mobile devices by instigating transmissions from devices in the vicinity. The instigated response reveals details about a targeted device, which allows the monitoring station to “fingerprint” the mobile device. In these systems, the mobile device being tracked operates in an ordinary and passive manner, and only responds to the monitoring stations by sending standard handshaking messages. In other words, the mobile device does not recognise that the monitoring stations are trying to track its location, nor does the mobile device actively cooperate with the tracking system to facilitate the location tracking.

One of the major shortcomings of the “noncooperative” tracking systems is that the coverage and accuracy of such a system depend essentially on the number of the monitoring stations. As these systems cannot utiise existing network infrastructures other than the monitoring stations, the only way to achieve a high coverage and accuracy is to set up a large number of monitoring stations, which can be costly and impracticable for large scale applications.

It is desired to address or ameliorate one or more disadvantages or limitations associated with the prior art, or to at least provide a useful alternative.

### SUMMARY

An embodiment of the present invention provides a method executed by a wireless electronic device, the method including the steps of:
(a) receiving, from a plurality of electronic devices, a unique identifier associated with each electronic device;
(b) identifying, from the plurality of electronic devices, at least one listening agent device;
(c) sending scan data to the listening agent device, the scan data including the unique identifiers received from one or more of the plurality of electronic devices other than the listening agent device;
wherein steps (a) to (c) are performed using a wireless communications protocol.

Another embodiment of the present invention provides a method executed by a listening agent device, including:
(a) sending to a wireless electronic device a listening agent identifier,
(b) authenticating that the wireless electronic device is a relevant wireless electronic device;
(c) receiving from the wireless electronic device scan data for locating the wireless electronic device; and
(d) communicating to a location server the scan data received from the wireless electronic device;
wherein steps (a) to (d) are performed using a wireless communication protocol; and
wherein the scan data contains one or more unique identifiers, each being associated with an electronic device other than the listening agent device, the electronic device being wirelessly communicable with the wireless electronic device.

Another embodiment of the present invention provides a wireless electronic device including:
a wireless communication module for wireless communication; and
a processor configured to control:
(a) receiving, from a plurality of electronic devices, a unique identifier associated with each electronic device;
(b) identifying, from the plurality of electronic devices, at least one listening agent device; and
(c) sending scan data to the listening agent device, the scan data including the unique identifiers received from one or more of the plurality of electronic devices other than the listening agent device;
wherein steps (a) to (c) are performed using a wireless communications protocol.

Another embodiment of the present invention provides a system including:
a wireless communication module for wireless communication; and
a processor configured to control:
(a) sending to a wireless electronic device a listening agent identifier;
(b) authenticating that the wireless electronic device is a relevant wireless electronic device;
(c) receiving from the wireless electronic device scan data for locating the wireless electronic device; and
(d) communicating to a location server the scan data received from the wireless electronic device;
wherein steps (a) to (d) are performed using a wireless communication protocol; and
wherein the scan data contains one or more unique identifiers, each being associated with an electronic device other than the listening agent device, the electronic device being wirelessly communicable with the wireless electronic device.

Another embodiment of the present invention provides a wireless electronic device including:
a wireless processor configured to send scan data in a probe request using a wireless signalling protocol to a listening agent access point;
wherein the scan data received by the listening agent access point is used to perform geolocation of the wireless electronic device; and
wherein the scan data includes unique identifiers received by the wireless electronic device from one or more access points other than the listening agent access point.

Another embodiment of the present invention provides a wireless network system including:
a geolocation computer system;
access points of wireless networks connected to the geolocation system; and
at least one of the above-described wireless electronic device.

### BRIEF DESCRIPTION OF THE DRAWINGS

Some embodiments of the present invention are hereinafter described, by way of example only, with reference to the accompanying drawings, wherein:

FIG. 1 is a schematic diagram of an exemplary system for locating a wireless electronic device;

FIG. 2 is a schematic diagram of an exemplary system for locating a wireless electronic device using a Wi-Fi communications protocol;

FIGS. 3-5 show an example of a tag wireless electronic device of the system;

FIG. 6 shows an example of a user interface for showing the locations of tracked objects;

FIG. 7 is a block diagram showing an exemplary structure of the tag device;

FIG. 8 is a block diagram showing an exemplary structure of the listening agent device of the system;

FIG. 9 is a diagram showing an exemplary structure of the cloud-based location server of the system;

FIG. 10 illustrates steps executed by the wireless electronic device in the locating process;

FIG. 11 illustrates steps executed by the listening agent device in the locating process;

FIG. 12 illustrates the format of an 802.11 management frame.

### DETAILED DESCRIPTION

A method and a system for locating one or more wireless electronic devices, described herein, address an important problem for enterprises and consumers by providing an accurate and updated location of their assets, pets, equipment, tools, bikes, musical instruments, cars, mobile phones, bags, luggage, or wallets.

According to at least some embodiments, the method and the system described herein provide a location and/or tracking solution that allows quick and accurate identification of wireless electronic devices, while utilising existing network infrastructures to deliver a locating service on greater scale and with enhanced coverage.

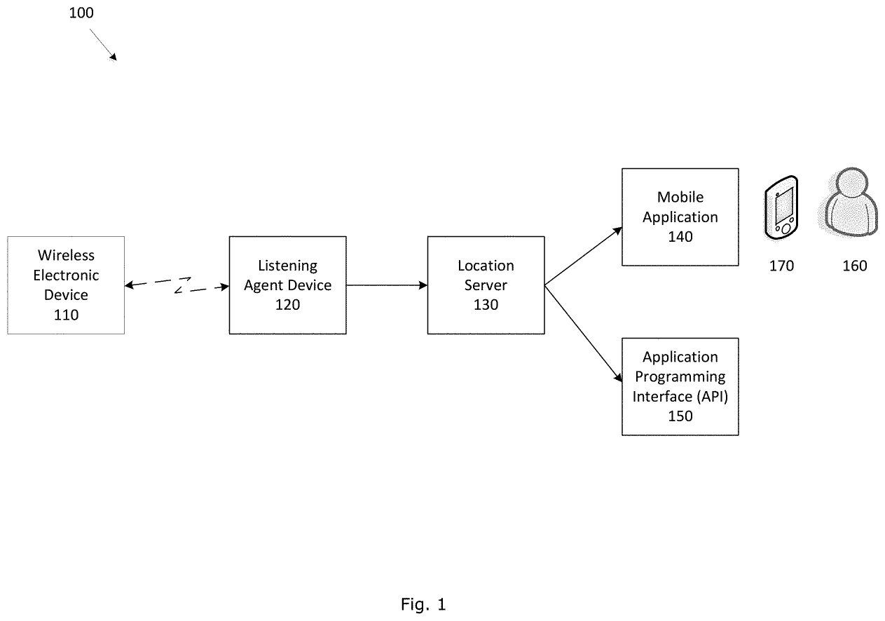

FIG. 1 is a schematic diagram of a system 100 for locating one or more wireless electronic devices, such as a wireless electronic device 110.

The wireless electronic device 110 is in wireless communication with one or more listening agent devices, such as a listening agent device 120. The wireless electronic device 110 has a unique device identifier that allows the listening agent device 120 to distinguish it from other electronic devices in the system 100.

The listening agent device 120 also has a unique device identifier that allows the wireless electronic device 110 to distinguish it from other electronic devices in the system 100. The listening agent device 120 further communicates to a location server 130.

Through the listening agent device 120 and the location server 130, location of the wireless electronic device 110 can be detected, and subsequently provided to one or more mobile applications 140 and/or application programming interfaces (APIs) 150 to provide locating services or other location-based services (LBS).

The locating process executed by the system 100 is summarised as follows.

Using a wireless communication protocol, the wireless electronic device 110 emits a scan message to search for electronic devices nearby that support the same wireless communication protocol.

One of the electronic devices that can communicate with the wireless electronic device 110 via the wireless communication protocol is the listening agent device 120. Upon receiving the scan message, the listening agent device 120 responds by sending a response including its unique identifier to the wireless electronic device 110. Other nearby electronic devices that have received the scan message via the wireless communication protocol also send their own unique identifiers to the wireless electronic device 110.

The system, in the listening agent device and/or the location server, filters out all irrelevant wireless electronic devices it sees. The system securely authenticate tags, and filters out all irrelevant wireless electronic devices, to protect against locating irrelevant wireless electronic devices and to ensure secure communication with relevant wireless electronic devices.

The wireless electronic device 110 extracts the unique identifiers from the responses received from the listening agent device 120 and other nearby electronic devices, and records these unique identifiers in a data store, e.g., an internal memory of the wireless electronic device 110.

Based on the response received from the listening agent device 120, the wireless electronic device 110 identifies that the device 120 is a listening agent device. The wireless electronic device 110 may also identify one or more other electronic devices nearby that are listening agent devices.

The wireless electronic device 110 then sends: (i) its own unique identifier, and (ii) the recorded unique identifiers it has received from the nearby electronic devices, to the listening agent device 120, and other nearby electronic devices that have been identified by the wireless electronic device 110 as listening agent devices.

Upon receiving the data (i) and (ii) from the wireless electronic device 110, the listening agent device 120 identifies based on the unique identifier of the wireless electronic device 110 that the wireless electronic device 110 is a device to be located by the system 100. The listening agent device 120 then reports the data (i) and (ii) received from the wireless electronic device 110 to the location server 130 via a communications network.

While the communication between the wireless electronic device 110 and the listening agent device 120 is wireless, the communications network between the listening agent device 120 and the location server 130 may be either a wireless network or a wired network, or a mix of both.

Using the data (i) and (ii) reported by the listening agent device 120, the location server 130 can then determine the location of the wireless electronic device 110, and subsequently communicate it to the one or more mobile applications 140 and/or APIs 150 to provide locating services or other location-based services to, for example, a user 160 who is associated with the wireless electronic device 110. The mobile applications 140 may be executed on a terminal computing device (i.e. client device) 170 used by the user 160.

The location server 130 may communicate with the terminal computing device 170 used by the user 160 via a wired or wireless network, or a mix of both.

The terminal computing device 170 may be a mobile terminal device. Optionally, a wireless gateway server may be provided between the mobile terminal device 170 and the location server 130 to control the data communication between them.

The wireless communications protocol used for communication between the wireless electronic device 110 and the listening agent device 120 may be any suitable type of wireless communication protocol, for example, Wi-Fi, Bluetooth, Zigbee, 3GPP Mobile Networking (for examples LTE Cat-M1), or any other suitable wireless communication protocol.

Locating System Based on Wi-Fi and/or Bluetooth

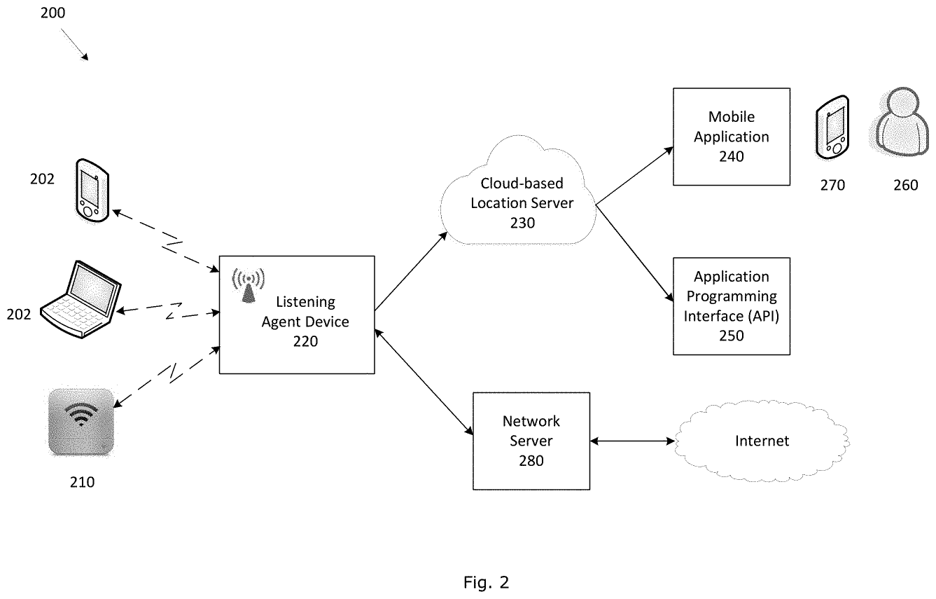

An example of a system 200 using Wi-Fi as the wireless communication protocol between the wireless electronic device 110 and the listening agent device 120 is illustrated in FIG. 2.

In this example, the wireless electronic device 110 is in the form of a tag device 210 which has a Wi-Fi communications module for wirelessly communicating using Wi-Fi, e.g., with a listening agent device 220. The wireless electronic device 110 may be attached to an object to be tracked, such as a user's wallet, bag, keys, bike, car, pet, luggage, musical instrument, or any other suitable item. In this way, by locating the wireless electronic device 110, the system 200 can determine the possible location of the object to be tracked.

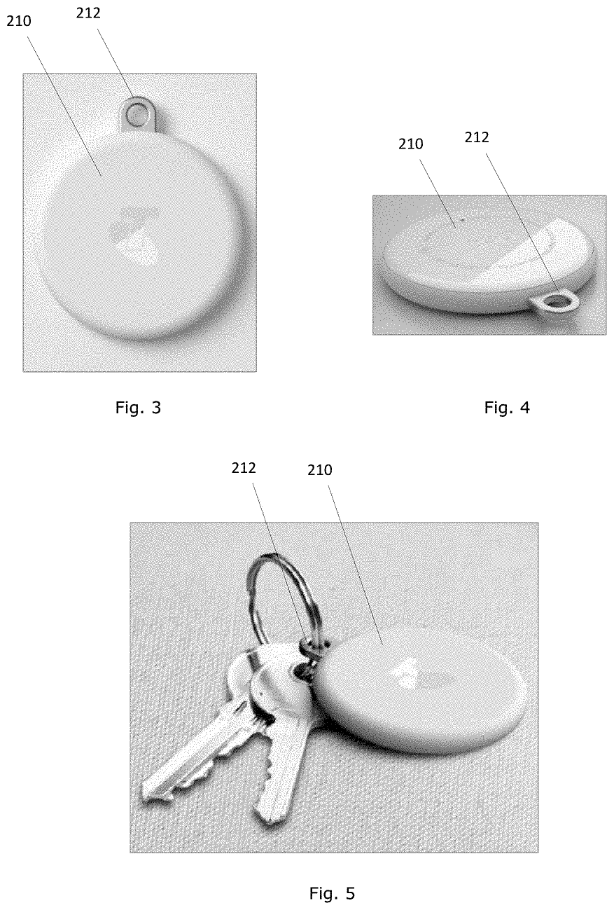

An example of the tag device 210 is illustrated in FIGS. 3-5. FIG. 3 is a front view of the tag device 210. FIG. 4 is a perspective view of the tag device 210. FIG. 5 shows an example of the tag device 210 attached to an item (a key ring).

In this example, tag device 210 has a slim rounded case, which gives the tag device 210 a flat circular external shape, and allows the tag device 210 to be readily attached to or inserted into an item. The tag device 210 may further include an attachment portion 212, for attaching the tag device 210 to an object to be tracked, as shown in FIGS. 3-5. Alternatively, the tag device 210 may be of any other suitable shape.

The listening agent device 220 may be formed by installing a listening agent software application on a Wi-Fi modem or Wi-Fi router device. This may enable utilisation of existing Wi-Fi hotspot devices and the Wi-Fi coverage provided by existing network infrastructure.

Accordingly, in addition to the wireless electronic device 210, the listening agent device 220 may also be in wireless communication with one or more terminal electronic devices 202 that are capable of Wi-Fi connection.

The listening agent 220 may also be incorporated into an application within the mobile terminal electronic devices 202. This may be implemented by an application which is specific to the wireless electronic device or in an existing application, such as a customer care application of a network service provider. Where the listening agent is incorporated into an existing application there is the potential to create a nationwide ‘crowd sourced’ network of listening agents that can detect the location of all tag devices 210, whenever they are in proximity or range of the mobile device 202 running the relevant application.

In this example, the location server 130 may take the form of a cloud-based location server 230, with which the listening agent device 220 is in data communication.

The cloud-based location server 230 may be built using any suitable cloud computing platform, for example, Microsoft Azure, Amazon Web Services, or the like.

In addition to the cloud-based location server 230, the listening agent device 220 may further be in communication with a network server 280 for handling other types of Wi-Fi data traffic, i.e., Wi-Fi data traffic that is not related to the locating service.

The tag device 210, the listening agent device 220, and the cloud-based location server 230 communicate with one another to perform the following locating process.

### Locating Process Using Wi-Fi

The tag device 210 performs an active scan by sending a Wi-Fi probe request and listening for probe responses from nearby electronic devices.

The electronic devices that are in Wi-Fi communication distance from the tag device 210 receive the probe request, and respond to it by sending a Wi-Fi probe response.

Among these electronic devices, apart from the listening agent device 220, one or more other devices may also be listening devices. In their probe responses to the tag device 210, the listening agent device 220 and other nearby listening agent devices indicate their listening capability by inserting a predetermined listening agent identifier into a vendor-specific information element (VSIE) of the probe response. The listening agent identifier may be, for example a binary sequence, such as an 8-bit binary sequence (2 bytes in hexadecimal).

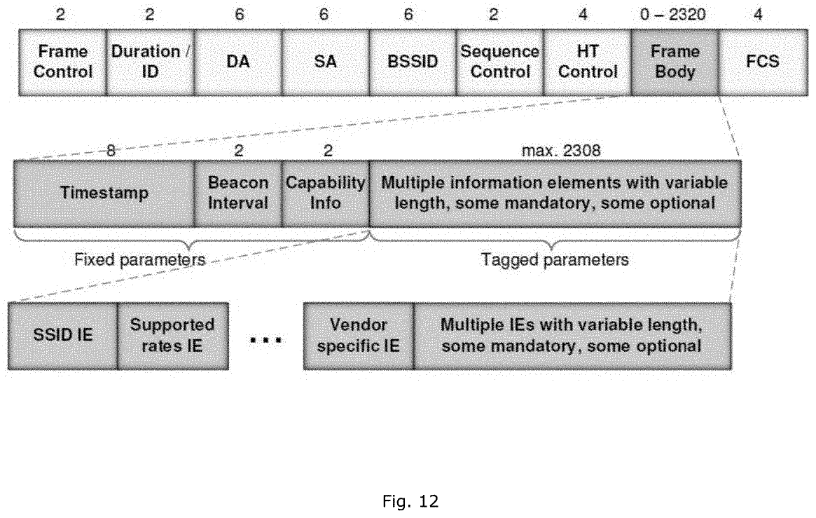

The probe responses, and the probe requests sent between the tag device 210 and the listening agent device 220 using Wi-Fi protocol are 802.11 management frames. When used in the locating process described herein the frames will include the VSIE. An exemplary structure of an 802.11 management frame (e.g., probe request or probe response frame) is shown in FIG. 12. The VSIE is included in the tagged parameters of the frame body.

For example, in some embodiments, the listening agent device 220 is a Wi-Fi Access Point device such as a Wi-Fi modem or Wi-Fi router device. The listening agent identifier may be a flag indicates that a listening agent software application has been installed on the Wi-Fi modem or Wi-Fi router device such that the Wi-Fi modem or Wi-Fi router device has listening capability.

In some embodiments, the listening capability on the listening agent device 220 may be enabled or disabled. For example, the listening capability on the listening agent device 220 may be disabled by default, and/or disabled on boot, and may be subsequently enabled by user operation. In some other examples, the listening capability may be disabled under predetermined conditions, for instance when the bandwidth between the listening agent device 220 and the cloud-based location server 230 falls below a predetermined bandwidth threshold value; the listening agent device 220 has failed over mobile broadband; or the user has disabled the Wi-Fi radio on the listening agent device 220.

If the listening capability has not been enabled or has been disabled, the listening agent device 220 will not include the listening agent identifier in the VSIE. This arrangement prevents the tag device 210 sending scan data as described hereinafter to a listening agent device with disabled listening capability. This facilitates optimizing the battery life of the tag device 210.

Upon receiving probe responses from nearby electronic devices, the tag device 210 records the unique identifier of each of these responding devices.

In this example, the unique identifier of each responding device may be the media access control address (MAC address) of the responding device. When the listening agent device 220 forms a Wi-Fi access point, the MAC address may also be referred to as the Basic service set identifier (BSSD).

The MAC address may be assigned by the manufacturer of the responding device following the format defined by the IEEE, which is a 6-byte (48-bit) or 8-byte (64-bit) binary address written in hexadecimal notation. The first three octets (24 bits) identify the organization that issued the identifier and are known as the Organizationally Unique Identifier (OUI). The remainder of the address (three octets for MAC-48 and EUI-48 or five for EUI-64) are assigned by that organization in any suitable manner subject to the constraint of uniqueness.

The tag device 210 may also record metadata associated with each responding device. The metadata may include, for example, one or more of the following: signal strength such as relative received signal strength (RSSI), communication channel, and signal-to-noise ratio (SNR) of each responding device.

The MAC addresses and the associated metadata of the responding devices are recorded by the tag device 210 as scan data. The scan data may further include a time stamp for each scan. The scan data will subsequently be provided via the listening agent device 220 to the cloud-based location server 230 for determination of the location of the tag device 210 as described hereinafter.

In addition to the MAC address, the tag device 210 also detects whether the probe response received from each responding device contains a vendor-specific information element (VSIE) indicating that the responding device has “listening capability”, i.e., that the responding device is a listening agent device. This can be determined by a flag set in the VSIE to indicate the responding device is a listening agent device, i.e. the listening agent flag referred to above.

In some embodiments, if the tag device 210 identifies one or more listening agent devices, it may send probe requests more frequently than if no listening agent device is identified.

If the tag device 210 identifies one or more of the responding devices are listening agent devices 220, the tag device 210 then sends: (i) its own unique identifier, and (ii) the recorded scan data, to the listening agent device 220 and other identified listening agent devices, for example via a probe request.

The unique identifier is a piece of data that allows the listening agent device 220 to identify that the tag device 210 is a device to be tracked by the system 200. The unique identifier of the tag device 210 and the scan data may be sent in the vendor-specific information element (VSIE) of the probe request sent from the tag device 210.

In some alternative embodiments, the unique identifier may be the MAC address of the tag device 210. For example, in the MAC address, the octets assigned by the manufacturer may be assigned in a way that allows a listening agent device, such as the listening agent device 220, to recognize that the device 210 is a device to be tracked. For example, a predetermined address range may be used when assigning MAC addresses to devices to be tracked such as the tag device 210. As the MAC address is data piece required in the probe response under the IEEE 802.11 standard, this reduces the amount of data to be transmitted in the VSIE of the probe request.

The data sent to the listening agent device 220 includes the scan data recorded from the most recent scan performed by the tag device 210.

Optionally, the data sent to the listening agent device 220 may further include scan history data, the scan history data being scan data recorded by the tag device 210 over a period of time. The scan history data may be timestamped with an offset from current time.

For example, the scan history data may include scan data recorded by the tag device 210 over a predetermined period of time, e.g., 3 mins, 5 mins, 30 mins, 1 hour, 12 hours, or any other suitable period of time.

Alternatively, the time range of the scan history data may be determined by the tag device 210 based on predetermined rules, e.g., the current battery level of the tag device 210. For instance, when the tag device 210 has a lower battery level, the amount of scan history data sent to the listening agent device 220 may be reduced. In some embodiments, a greater amount of scan history data may be sent to the listening agent device 220 in order to provide finer granularity of location history at the expense of battery life.

Apart from the unique identifier and the scan data, the tag device 210 may additionally send additional data in the VSIE of the probe request to the listening agent device 220 and other identified listening agent devices. For example, in some embodiments, the tag device 210 may further send battery level data indicative of its battery level. In some other embodiments, the tag device 210 may further send data indicative of the firmware version of the tag device 210. The firmware version may allow for problem diagnostics or checking for software updates related to the tag device 210.

Optionally, the scan data and the additional data may be encoded by the tag device 210 using a predetermined format before being inserted into the VSIE of the probe request.

The amount of data embedded in the VSIE may be subject to the restriction of the 802.11 standard. For example, in some implementations, the VSE may be restricted to 251 bytes (about 8 bytes in hexadecimal) of data.

The data sent by the tag device 210 in the VSE may also be referred to as “tag data”. An example of the tag data sent by the tag device 210 is shown in Table I.

TABLE I
An example of tag data

| Field | | Size in Bits | Comment |
|---|---|---|---|
| Packet Identifier | | 5 | Reserved for future use |
| Battery Level | | 7 | |
| Version | Major | 8 | |
| | Minor | 8 | |
| Scan ID | | 7 | Increments on each scan |
| Found Gateway Counter | | 5 | Up to 31 |
| Repeated Gateways | Channel | 4 | |
| | Negative RSSI | 7 | ie −48 dBm −> 0x30 |
| | SNR | 7 | Signal to noise ratio |
| | BSSID | 48 | |
| Historic Report Counter | | 3 | Number of historic reports |
| | | | present maximum 4 |
| Historic report n | Scan ID | 7 | Increments on |
| | | | each scan |
| | Time | 8 | Negative offset relative |
| | | | to current report |
| | Found GW Counter | 4 | Up to 15 |
| | Channel | 4 | |
| | Negative RSSI | 7 | ie −48 dBm −> 0x30 |
| | SNR | 7 | Signal to noise ratio |
| | BSSID | 48 | |
| Historic report n + 1 | Scan ID | 7 | Increments on each scan |
| | Time | 8 | Negative offset relative |
| | | | to current report |
| | Found GW Counter | 4 | Up to 15 |
| | Channel | 4 | |
| | Negative RSSI | 7 | ie −48 dBm −> 0x30 |
| | SNR | 7 | Signal to noise ratio |
| | BSSID | 48 | |

The probe request may be sent by the tag device 210 on one or more Wi-Fi communication channels. For example, the probe request may be sent on channel 1, 6 and 11.

After sending the probe request to the listening agent device 220 and other identified listening agent devices, the tag device 210 may switch to a sleep mode, and wake up periodically to perform the scan process as described above.

Upon receiving the probe request from the tag device 210, the listening agent device 220 checks for the unique identifier of the tag device 210 to determine whether the tag device 210 is a device to be tracked by the system 200, for example, by checking the VSIE of the probe request, or the MAC address of the tag device 210.

If the listening agent device 220 identifies that this probe request is sent from a device to be tracked, the listening agent device 220 stores the payload of the VSIE field of the probe request (tag data) together with the MAC address of the tag device 210, e.g., in a memory 820 of the listening agent device 220. The listening agent device 220 may log these data items together with a timestamp, e.g., a time using the Coordinated Universal Time (UTC) standard.

The listening agent device 220 then uploads the tag data, including the MAC address of the tag 210, received from the tag device 210 to the cloud-based location server 230. A message is sent from the listening agent device 220 to the cloud-based location server 230 to upload this data referred to as a “tag message”.

The upload of the information may be performed periodically at predetermined time intervals. For example, every 60 seconds, the listening agent device 220 uploads the tag data it has logged over the last 60 seconds to the cloud-based location server 230. The listening agent device 220 may send the tag data to the cloud-based location server 230 over a public, private or shared network.

The tag data sent to the cloud-based location server 230 may be encoded and encrypted by the listening agent device 220, and may be sent via an existing web transfer protocol such as the Constrained Application Protocol (CoAP). The tag data may be encoded as Base 64 in the JSON format.

When encrypting and uploading the tag data, the listening agent device 220 may encrypt and upload logged tag data of one tag device at a time, e.g., tag data of one tag device per CoAP request, such that a dropped packet does not corrupt uploaded tag data of more than one tag device.

Optionally, the listening agent device 220 may re-upload the tag data a predetermined number of times, so as to mitigate risk of data loss during transmission. Accordingly, the cloud-based location server 230 may be configured to detect duplicate upload events and filter out duplicate upload. For example, when sending tag data, the listening agent device 220 may assign an identifier to each batch of data uploaded to allow the cloud-based location server 230 to identify duplicate reports.

After the upload has completed, the listening agent device 220 may clear its log of observed tag devices by deleting the tag data.

In some embodiments, the listening agent device 220 is a Wi-Fi Access Point device such as a Wi-Fi modem or Wi-Fi router device.

Accordingly, apart from the tag device 210, the listening agent device 220 may receive probe requests and/or other Wi-Fi messages from other types of wireless devices. Probe requests from irrelevant wireless electronic devices are filtered out and dropped from further location processing by the system, in the listening agent device 220 and/or the location server 230. The system securely authenticates tag devices 210, and filters out all irrelevant wireless electronic devices, to protect against locating irrelevant wireless electronic devices and to ensure secure communication with relevant wireless electronic devices. Data received from non-tag devices (e.g., the one or more terminal electronic devices 202 shown in FIG. 2) are handled by the listening agent device 220 as part of the standard 802.11 Base Service Set (BSS), and communicated to one or more standard Wi-Fi Access Point servers (e.g., the network server 280 shown in FIG. 2) that handle conventional Wi-Fi data traffic, rather than the cloud-based location server 230.

If the tag data received from the listening agent device 220 is encrypted, the cloud-based location server 230 will decrypt the tag data, and may further decode the tag data if the received tag data is encoded.

Using the tag data received from the listening agent device 220, the cloud-based location server 230 can then determine the location of the tag device 210. When determining the location of the tag device 210, the cloud-based location server 230 extracts the scan data from the tag data, and then determines the listening agent devices 220 detected by the tag device 210 in the scan. The cloud-based location server 230 then queries a listening agent device database to retrieve the geolocation of each listening agent device 220 recorded in the scan data, and calculate the location or a possible location range of the tag device 210 based on the geolocation of the listening agent devices observed by the tag device 210, and the relative received signal strength (RSSI) and Signal-to-noise ratio (SNR) associated with each listening agent device as indicated by the scan data and the time indicated by the timestamps in the scan data. The steps executed to determine the location of a tag device 210 based on this data are as follows: The RSSI & SNR indicate the relative distance the tag device 210 is from each listening agent device 220. These distances are used to plot intersecting location areas using geolocation services.

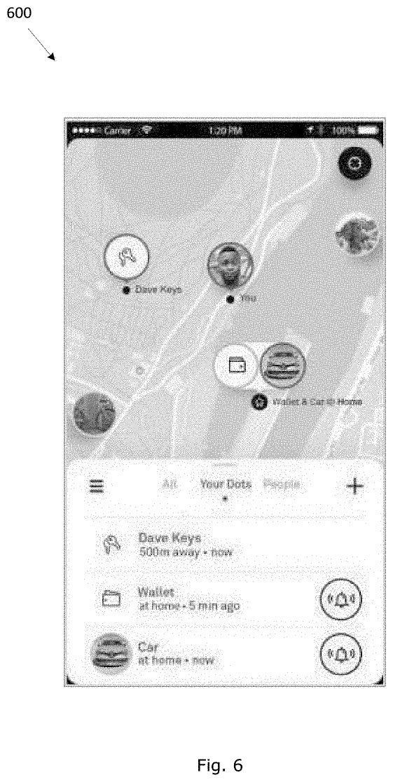

The determined location of the tag device 210 may then be communicated to a mobile application 240 executed on a mobile terminal device 270 used by the user 260 associated with the tag device 210. For instance, a graphical user interface may be displayed on a screen of the mobile terminal device 270, showing on a map the location of the tag device 210 in association with the object to which the tag 210 is attached. An example of the user interface 600 showing the locations of a number of tag devices in association with a number of objects being tracked is depicted in FIG. 6.

Additionally, the cloud-based location server 230 may further communicate the location of the tag device 210 to one or more addressable APIs 250 that may be accessed by additional applications to provide other location-based services.

The locating process as described above allows the tag device 210 to utilise the 802.11 Wi-Fi signalling protocol to generate and send data which can be used to calculate the geolocation of the tag device 210. Also by using the 802.11 signalling protocol, the listening agent device 220 advertises its capability for receiving geolocation-related data from a tag device 210. In this way, the described method and system allow utilisation of existing Wi-Fi network deployment to transport geolocation-related data from a tag device.

Further, in the process described above, apart from the probe response from the listening agent device 220 and other nearby listening agent devices, no significant data flows back to the tag device 210. This improves the battery life for the tag device 210.

In at least some embodiments, the listening agent software application is lightweight and energy efficient, so that it can be implemented in a wide range of devices including mobile handsets, mobile Wi-Fi broadband modems, and other battery-operated Wi-Fi devices as well as home modems, business modems, enterprise modems and public Wi-Fi hot spots.

### Scalability

Although FIG. 2 only illustrates one tag device 210, one listening agent device 220, and one cloud-based location server 230, the described locating process may readily be scaled to millions of listening devices 220 (e.g., mobile terminal devices, Wi-Fi modems/routers, and/or LTE base stations), tens of millions of location application users, and hundreds of millions of tag devices 220, thus allowing for leveraging existing Wi-Fi, LTE, and/or other wireless/fixed sharing network infrastructure. With the unique design of the tag devices, utilisation of MAC addresses and/or other form of unique identifiers, as well as novel development of the listening agent software application which can be deployed to Wi-Fi modems and existing applications on mobile devices, cloud-based location server and associated software, and the mobile application for locating the tag devices, the system 100 can operate on a regional, national or international scale at a low cost with good battery life. Furthermore, the tag devices may be formed in small sizes and slim shapes, and thus can be easily and conveniently attached to objects to be tracked.

### Security Measures

In some embodiments, the wireless communication protocol, listening agent device 220, and cloud-based location server 230 may further include security measures to prevent rogue devices from masquerading as tag devices and communicating with the listening agent device 220. For example, each tag device 210 may generate a unique number sequence which can be predicted and validated by the cloud-based location server 230.

### Extensibility to Alternative/Additional Wireless Protocols

In the implementations describe above, the wireless communication protocol between the tag device 210 and the listening agent device 220 is Wi-Fi. Alternatively or additionally, other suitable wireless communication protocol(s) may be used for transport data between the tag device 210 and the listening agent device 220, for example, Bluetooth and/or Zigbee.

In order to adapt the system 200 to use other wireless communication protocols, a number of changes may be made to the architecture of the system 200.

For example, the tag device 210 may be configured to further include one or more communication modules for enabling data communication using other wireless networking protocols (e.g. Bluetooth, Zigbee, GPS). Optionally, a unique identifier may also be assigned for one or more these alternative or additional wireless networking protocols, in order to indicate that the device 210 is a tag device. For example, a predetermined address range may be used by a manufacture when assigning Bluetooth or Zigbee MAC addresses to tag devices such as the tag device 210.

In some embodiments, the tag device 210 may be configured to allow communication with nearby wireless devices using more than one wireless communication protocols. Accordingly, when performing the scan, the tag device 210 may send probe requests or other suitable handshake messages using each communication protocol, and listening for responses from nearby devices using each communication protocol.

Correspondingly, the listening agent device 220 may also be enhanced with the appropriate radio and wireless communication protocol (e.g. Bluetooth, Zigbee, GPS), and may listen for handshake messages from tag devices under the alternative or additional wireless communication protocol. Further, by knowing the range of the Wi-Fi, Bluetooth, or Zigbee MAC addresses, the listening agent device 220 is able to identify a MAC address as a tag device.

In some embodiments, more than one wireless communication protocols may be used for transporting data between the listening agent device 220 and one or more tag devices. Accordingly, the listening agent device 220 may use all of these wireless communication protocols (e.g., Wi-Fi, Bluetooth, and Zigbee) sequentially to listen for tag devices advertising their identity in range, or issue appropriate beacon or handshake frames in each wireless protocol sequentially.

The tag data may also include location data obtained by the tag device 210. For example, GPS data may be included in the tag data, if the tag device 210 has both a GPS radio and a Wi-Fi and/or other radios. For tag devices that support GPS as well as Wi-Fi and or LTE communication capabilities (for example LTE Cat-M1 long-range low-power communication), the tag device 210 sends location data which is then passed by the listening agent device 220 to the cloud-based location server 230.

Mobile devices, for example the mobile terminal device 270 used by user 260, can also be locatable wireless electronic devices if they have a software module downloaded and enabled which performs the capabilities of a tag device (e.g. tag device 210) using the hardware and system of the mobile device.

The rest of the system 220 may work in a substantially same way for different wireless communication protocols.

### Tethering Mode and Lost Mode

In some embodiments, the tag device 210 may have a tethering mode and a lost mode. The tethering mode indicates that the tag device 210 is or is likely to be in a predetermined range from its owner. The lost mode indicates that the tag device 210 is or is likely to be outside the predetermined range from the owner.

For example, in an initialization process, the tag device 210 having a Wi-Fi communication module may be operated by a user (e.g., the owner) to record the BSSIDs of the home Wi-Fi environment of the user. Alternatively or additionally, if the tag device 210 has a Bluetooth for Bluetooth communication, the user may pair the tag device 210 with one or more Bluetooth device(s) of the user.

During normal operation, the tag device 210 will periodically wake up and check whether the home Wi-Fi environment and/or the Bluetooth device(s) is in range.

If the home Wi-Fi environment and/or the Bluetooth device(s) remain connected, the tag device 210 remains in the tethering mode and wakes up at a predetermined frequency.

If the home Wi-Fi environment and/or the Bluetooth device(s) are out of range, the tag device 210 will enter the lost mode and wake up more frequently than in the tethering mode.

In some embodiments, the conditions for switching between the tethering mode and the lost mode, or the wake up frequencies of the two modes may be configurable by the user.

When the tag device 210 is in lost mode, it may send out a broadcast probe request on each Wi-Fi communication channel (1-11) sequentially, to perform a Wi-Fi scan and record the BSSIDs, channels, and RSSI of the Wi-Fi access points it observes.

The tag device 210 also examines the VSIE of the observed Wi-Fi probe responses to determine whether any listening agent device is in range. The tag device 210 will log the list of observed access points together with the local time.

If the tag device 210 observes any nearby devices advertising listening capability, it may encode the log of observed access points, together with the battery level and firmware version of the tag device 210. It may send a probe request to the BSSID which was identified to be listening capable, and populate the encoded data in the VSIE of probe requests.

If multiple listening agent devices were identified, the probe request may be sent to the BSSID with the highest RSSI. If no response is received from the probe request, the tag device 210 may retry, or attempt to probe an alternative listening agent device.

The tag device 210 may include a list of historic reports, with a time offset, to provide a location history, e.g. if it did not observe a listening agent device on its previous attempt.

When not in lost mode, the tag device 210 sends a probe request with this information less frequently, e.g., only once per day.

By having the tethering mode and the lost mode, and adjusting the frequency of sending probe requests accordingly, the battery performance and longevity of the tag device 210 may be further improved.

### Active Mode and Passive Mode

A Wi-Fi client device can have two scanning modes: active scan and passive scan. During an active scan, the client radio transmits a probe request and listens for a probe response from an Access Point. With a passive scan, the client radio listens on each channel for beacons sent periodically by an Access Point.

In at least some of the implementations described above, the wireless communication between the tag device 210 and the listening agent device 220 is initiated by the tag device 210 sending out probe requests. That is, the tag device 210 performs active scans. Working in active scanning mode may allow the tag device 210 to find nearby listening agent devices more quickly, as the tag device 210 does not need to listen and wait for a beacon to be sent.

In some alternative embodiments, the tag device 210 may work in a passive scanning mode, by listening for the beacons sent from nearby devices. Upon receiving the beacons, the tag device 210 may record the unique identifier of the devices sending the beacons, and also detect whether the beacon received from each of these devices contains a VSIE indicating that the responding device has listening capability, i.e., that the responding device is a listening agent device. If the tag device 210 identifies any listening agent device, the tag device 210 then sends the scan data in the VSIE of a probe response to the nearby device that has broadcasted listening capability.

The rest of the process may be substantially the same as when the tag device 210 works in the active scanning mode.

In some further embodiments, the tag device 210 may be capable of working either in an active scanning mode or a passive scanning mode, and may switch between the active scanning mode and the passive scanning mode depending on user input, or predetermined rules. For example, the tag device 210 may perform passive scanning when in the tethering mode as described above, and perform active scanning when switched to lost mode.

The beacons, the probe responses, and the probe requests sent between the tag device 210 and the listening agent device 220 using Wi-Fi protocol are 802.11 management frames. When used in the locating process described above the frames will include the VSIE.

### Extensibility to Additional Network Access Technologies

A variety of network access technologies may be used in the method and system as described above. Apart from the short-range network technologies (e.g. Wi-Fi, Bluetooth, Zigbee) as described above, long-range network technologies such as GPS, LoRa, as well as 4G/5G Internet of things (IoT) and Mobile network technologies such as LTE Cat M1, LTE Cat NB1 may also be used in the locating system, e.g., for transmitting data between the listening agent device 220 and the cloud-based location server 230, and between the cloud-based location server 230 and the mobile terminal device 270 and the API 250. The described method and system may be readily applied by telecommunications operators to existing regional, national, and international communication networks and mobile sharing networks such as Wi-Fi sharing networks, to provide significant indoor and outdoor coverage by utilising existing network infrastructure.

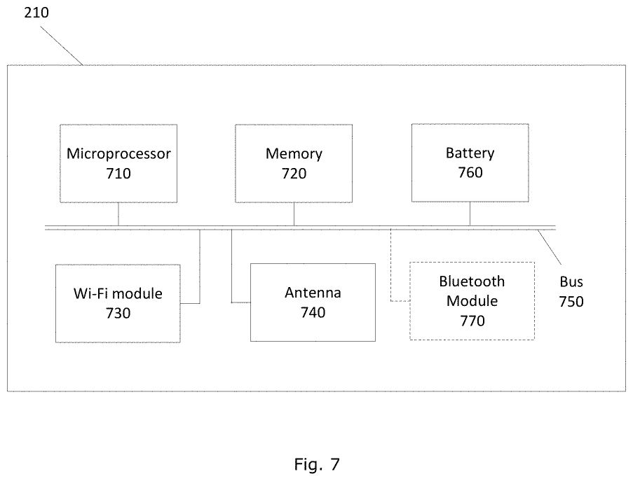

A block diagram showing an exemplary structure of the tag device 210 is illustrated in FIG. 7.

In this example, the tag device 210 includes at least one microprocessor 710, memory 720, a Wi-Fi module 730, and an antenna 740, interconnected via a bus 750 as shown. The tag device 210 further includes a battery unit 760 for accommodating one or more batteries.

As described hereinbefore, in addition to or instead of the Wi-Fi module 730, the tag device 210 may include other type of wireless communication module to enable communication using other wireless communication protocol(s), e.g., Bluetooth or Zigbee. In some embodiments, the tag device 210 may support a plurality of wireless communication protocols. For example, the tag device 210 may include both the Wi-Fi module 730 and a Bluetooth module 770.

In addition, in some embodiments, the tag device 210 may further include one or more input/output modules. For example, one or more buttons for enabling user operation, and/or one or more LED lights for indicating the working status of the tag device 210.

The microprocessor 710 executes computer program instructions in the form of application software stored in the memory 720 to perform the listening process and communicate with the listening agent device 220.

As described hereinbefore, the listening agent device 220 may be a Wi-Fi Access Point device such as a Wi-Fi modem or Wi-Fi router device.

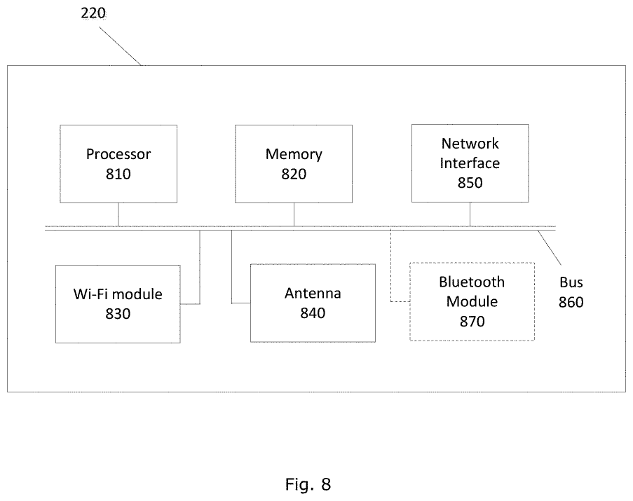

A block diagram showing an exemplary structure of the listening agent device 220 is illustrated in FIG. 8.

In this example, the listening agent device 220 includes at least one processor 810, a memory 820, a Wi-Fi module 830, one or more antennas 840, and a network interface 850, interconnected via a bus 860 as shown.

As described hereinbefore, in additional to or instead of the Wi-Fi module 830, the listening agent device 220 may include other types of wireless communication module to enable communication using other wireless communication protocol(s), e.g., Bluetooth or Zigbee. In some embodiments, the listening agent device 220 may support a plurality of wireless communication protocols. For example, in addition to the Wi-Fi module 830, the listening agent device 220 may further include a Bluetooth Module 870 for Bluetooth communication.

In addition, in some embodiments, the listening agent device 220 may further include one or more input/output modules. For example, one or more buttons for enabling user operation, and/or one or more LED lights for indicating the working status of the listening agent device 220.

The microprocessor 810 executes computer program instructions in the form of application software stored in the memory 820 to perform the listening process and communicate with the tag device 210, the one or more wireless terminal electronic devices 202, the cloud-based location server 230, and the network server 280.

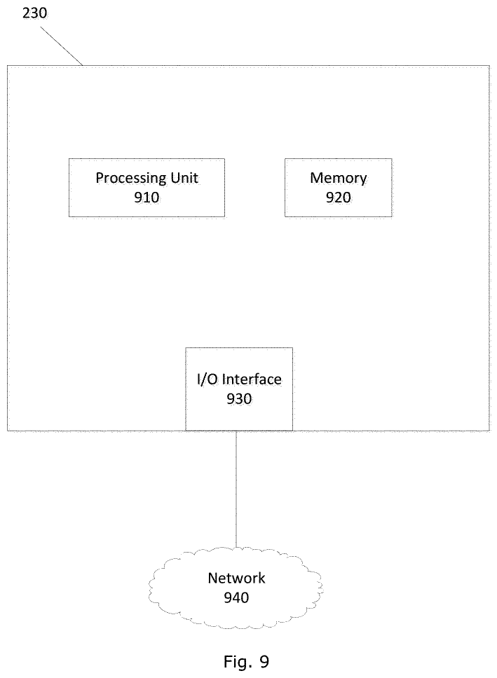

A diagram showing an exemplary structure of the cloud-based location server 230 is illustrated in FIG. 9.

In this example, the cloud-based location server 230 includes a computer processing unit 910, a memory 920, and an input/output interface 930, connected via a communications network 930. The input/output interface 930 may be utilised for communication with the listening agent device 220, the one or more mobile applications 240, and the one or more APIs 250. In use, the processing unit 910 executes computer program instructions in the form of application software stored in the memory 920 to perform the locating process.

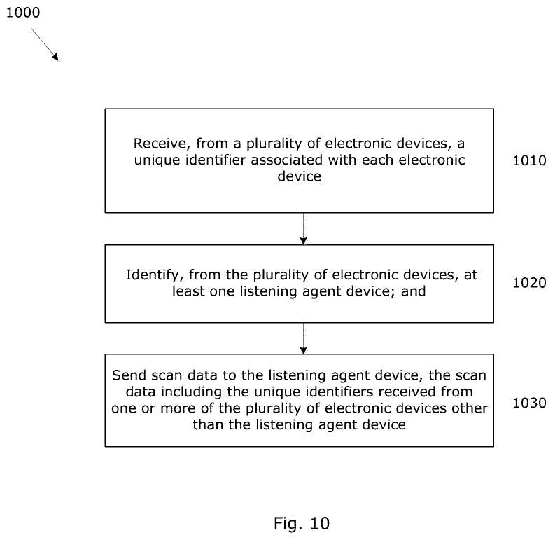

FIG. 10 illustrates a tag process 1000 implemented by the wireless electronic device 110 in the locating process.

At step 1010, the wireless electronic device 110 receives, from a plurality of electronic devices, a unique identifier associated with each electronic device.

At step 1020, the wireless electronic device 110 identifies, from the plurality of electronic devices, at least one listening agent device 120.

At step 1030, the wireless electronic device 110 sends the scan data to the listening agent device 120, the scan data including the unique identifiers received from one or more of the plurality of electronic devices other than the listening agent device, and a unique tracking identifier associated with the wireless electronic device 110.

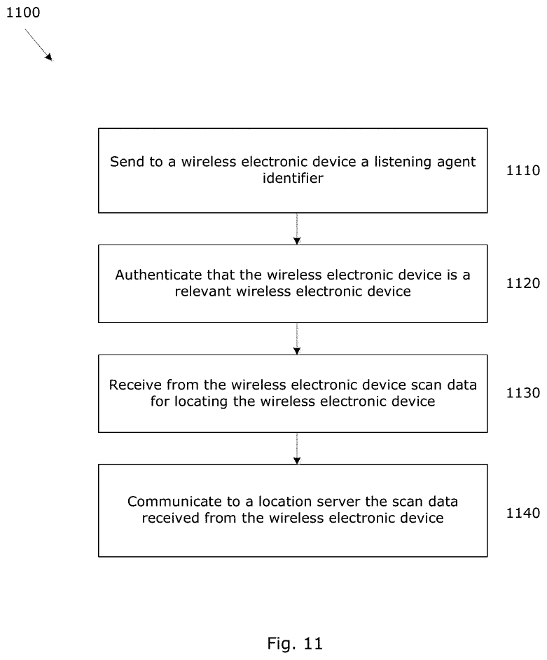

FIG. 11 illustrates a listening process 1100 implemented by the listening agent device 120 in the locating process.

At step 1110, the listening agent device 120 sending to the wireless electronic device 110 the listening agent identifier.

At step 1120, the listening agent device 120 authenticating that the wireless electronic device is a relevant wireless electronic device.

At step 1130, the listening agent device 120 receives from the wireless electronic device the scan data for locating the wireless electronic device 110.

At step 1140, the listening agent device 120 communicates to the location server 230 the scan data received from the wireless electronic device 110.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Many modifications will be apparent to those skilled in the art without departing from the scope of the present invention as hereinbefore described with reference to the accompanying drawings.

1. A method executed by a wireless electronic device, the method including the steps of:
(a) receiving, from a plurality of electronic devices, a unique identifier associated with each electronic device;
(b) identifying, from the plurality of electronic devices, at least one listening agent device; and
(c) sending scan data to the listening agent device, the scan data including the unique identifiers received from one or more of the plurality of electronic devices other than the listening agent device, and a unique tracking identifier associated with the wireless electronic device;
wherein steps (a) to (c) are performed using a wireless communications protocol.

2. The method of claim 1, wherein the wireless communication protocol is Wi-Fi.

3. The method of claim 1, wherein the wireless communication protocol is Bluetooth.

4. The method of claim 2, wherein the unique identifier is received in a first 802.11 management frame; and the scan data is sent in a second 802.11 management frame.

5. The method of claim 4, wherein
the first 802.11 management frame is a probe response; and
the second 802.11 management frame is a probe request.

6. The method of claim 4, wherein the scan data is sent in a vendor-specific information element (VSIE) of the second 802.11 management frame.

7. The method of claim 4, wherein the listening agent device is identified based on a listening agent identifier received from the respective electronic device.

8. The method of claim 7, wherein the listening agent identifier is received in a vendor-specific information element (VSIE) of the first 802.11 management frame.

9. The method of claim 1, wherein the unique identifier associated with each electronic device is a media access control (MAC) address of the electronic device.

10. The method of claim 1, wherein the scan data further includes:
signal strength data, indicating the signal strength of the wireless communication with each of the one or more electronic devices.

11. The method of claim 1, wherein the scan data further includes:
scan history data, the scan history data includes data received by performing step (a) over a period of time.

12. The method of claim 1, further including:
adjusting the amount of scan data sent to the listening agent device based on predetermined rules.

13. The method of claim 12, wherein the predetermined rules include:
reducing the amount of scan data sent to the listening agent device when wireless electronic device has a lower battery level.

14. The method of claim 1, further including:
switching the wireless electronic device from a first mode to a second mode, wherein in the second mode step (a) is performed more frequently than in the first mode.

15. A method executed by a listening agent device, including:
(a) sending to a wireless electronic device a listening agent identifier;
(b) authenticating that the wireless electronic device is a relevant wireless electronic device;
(c) receiving from the wireless electronic device scan data for locating the wireless electronic device; and
(d) communicating to a location server the scan data received from the wireless electronic device;
wherein steps (a) to (d) are performed using a wireless communication protocol; and
wherein the scan data contains one or more unique identifiers, each being associated with an electronic device other than the listening agent device, the electronic device being wirelessly communicable with the wireless electronic device.

16. The method of claim 15, wherein the wireless communication protocol is Wi-Fi.

17. The method of claim 15, wherein the wireless communication protocol is Bluetooth.

18. The method of claim 16, wherein the listening agent identifier is sent in a first 802.11 management frame; and the scan data is received in a second 802.11 management frame.

19. The method of claim 18, wherein the first 802.11 management frame is a probe response and the second 802.11 management frame is a probe request.

20. The method of claim 18, wherein the scan data is received in a vendor-specific information element (VSIE) of the second 802.11 management frame.

21. The method of claim 18, wherein the listening agent identifier is sent in a vendor-specific information element (VSIE) of the first 802.11 management frame.

22. The method of claim 15, wherein the scan data further includes signal strength data, indicating the signal strength of the wireless communication of the wireless electronic device with each of the one or more electronic devices.

23. The method of claim 15, further including:
receiving from the wireless electronic device a unique tracking identifier associated with the wireless electronic device;
wherein whether the wireless electronic device is a relevant wireless electronic device is determined based on the unique tracking identifier.

24. The method of claim 15, wherein the wireless electronic device is a tag device attached to an object.

25. The method of claim 15, wherein the listening agent device is a mobile device with an application installed and configured to perform steps (a) to (d).

26. A wireless electronic device including:
a wireless communication module for wireless communication; and
a processor configured to control:
(a) receiving, from a plurality of electronic devices, a unique identifier associated with each electronic device;
(b) identifying, from the plurality of electronic devices, at least one listening agent device; and
(c) sending scan data to the listening agent device, the scan data including the unique identifiers received from one or more of the plurality of electronic devices other than the listening agent device;
wherein steps (a) to (c) are performed using a wireless communications protocol.

27. A system including:
a wireless communication module for wireless communication; and
a processor configured to control:
(a) sending to a wireless electronic device a listening agent identifier;
(b) authenticating that the wireless electronic device is a relevant wireless electronic device;
(c) receiving from the wireless electronic device scan data for locating the wireless electronic device; and
(d) communicating to a location server the scan data received from the wireless electronic device;
wherein steps (a) to (d) are performed using a wireless communication protocol; and
wherein the scan data contains one or more unique identifiers, each being associated with an electronic device other than the listening agent device, the electronic device being wirelessly communicable with the wireless electronic device.

28. A wireless electronic device including:
a wireless processor configured to send scan data in a probe request using a wireless signalling protocol to a listening agent access point;
wherein the scan data received by the listening agent access point is used to perform geolocation of the wireless electronic device; and
wherein the scan data includes unique identifiers received by the wireless electronic device from one or more access points other than the listening agent access point.

29. A wireless network system including:
a geolocation computer system;
access points of wireless networks connected to the geolocation system and distributed in various locations; and
at least one wireless electronic device of claim 28.
